(19) United States
(12) Patent Application Publication
(10) Pub. No.: US 2019/0016469 A1
(43) Pub. Date: Jan. 17, 2019

(54) Deceleration Apparatus

(71) Applicant: Thomas C. Wilkes, Middletown, CT (US)

(72) Inventor: Thomas C. Wilkes, Middletown, CT (US)

(21) Appl. No.: 15/649,158

(22) Filed: Jul. 13, 2017

(51) Int. Cl. B64D 19/02; B64D 1/02

(52) U.S. Cl. CPC B64D 19/02; B64D 1/02

(57) ABSTRACT

Disclosed is a deceleration apparatus comprising a main center shaft; a plurality of disks; and, a means for moving each disk along the longitudinal axis of the main center shaft; wherein each disk comprises an outer annular ring, a plurality of vanes, and an inner annular ring; wherein each vane having an outer end and an inner end; wherein each vane extends between the outer annular ring and the inner annular ring; wherein the outer end is coupled to the outer annular ring; wherein the inner end is coupled to the inner annular ring; and, wherein the inner annular ring of each disk is movably attached to the main center shaft. The deceleration may further comprise a connector and a cargo container. The means for moving each disk along the longitudinal axis of the main center shaft may include a motorized winch.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a novel deceleration apparatus configured to retard or slow the motion or velocity of cargo as it descends through the atmosphere by inducing drag.

### BRIEF SUMMARY OF THE INVENTION

An object of the present invention is a deceleration apparatus comprising a main center shaft; a plurality of disks; and, a means for moving each disk along the longitudinal axis of the main center shaft; wherein each disk comprises an outer annular ring, a plurality of vanes, and an inner annular ring; wherein each vane having an outer end and an inner end; wherein each vane extends between the outer annular ring and the inner annular ring; wherein the outer end is coupled to the outer annular ring; wherein the inner end is coupled to the inner annular ring; and, wherein the inner annular ring of each disk is movably attached to the main center shaft.

Another object of the present invention is a deceleration apparatus that further comprising a connector and a cargo container.

Yet another object of the present invention is a deceleration apparatus, wherein the means for moving each disk along the longitudinal axis of the main center shaft includes a motorized winch.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a side elevational view of an embodiment of the deceleration apparatus.

FIG. 2 is a top plan view of an embodiment of the disk.

FIG. 3 is a top plan view of an alternative embodiment of the disk.

### DETAILED DESCRIPTION OF THE INVENTION

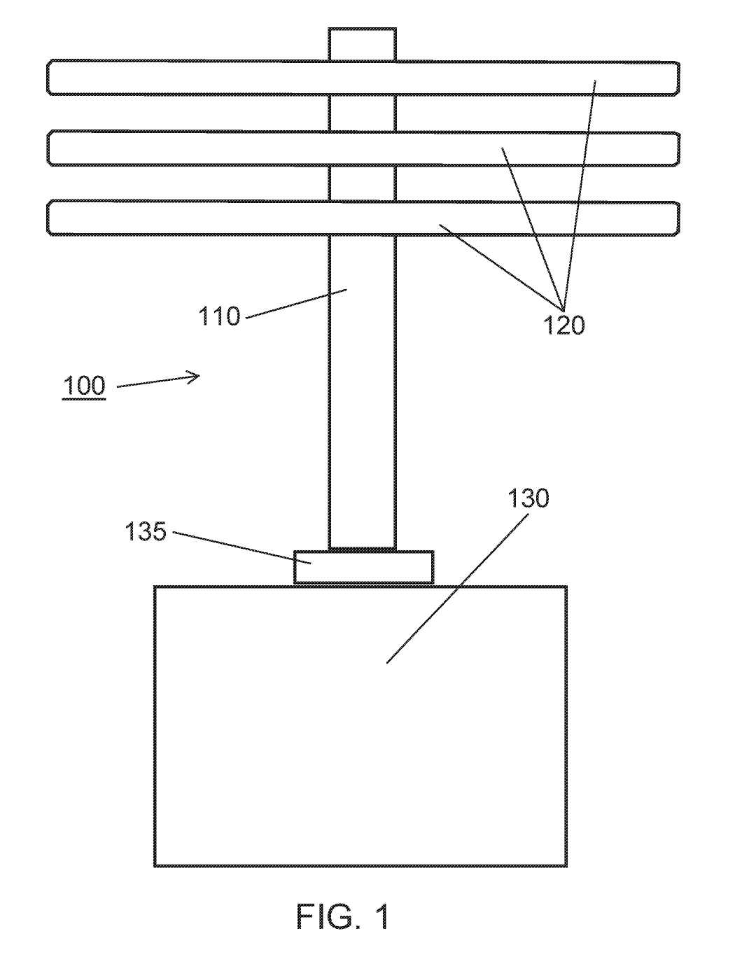

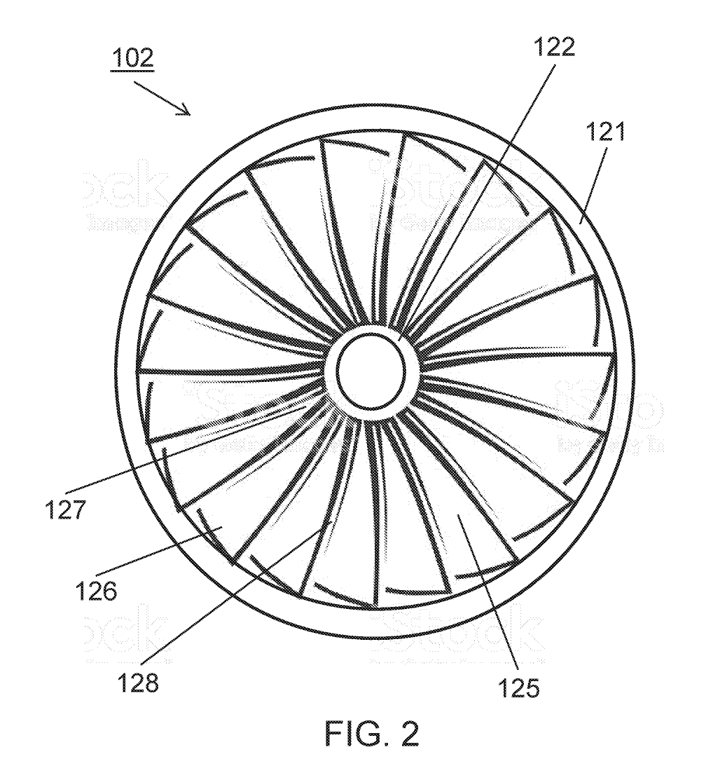

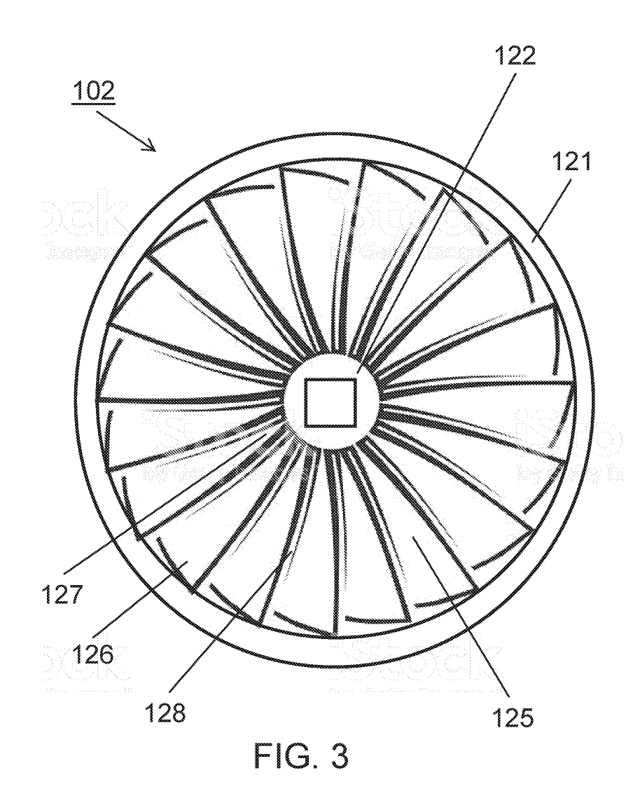

FIG. 1 shows an embodiment of the present invention. A deceleration apparatus 100 comprises a main center shaft 110; a plurality of disks 120; and, a means for moving each disk 120 along the longitudinal axis of the main center shaft 110. As depicted in FIGS. 2 and 3, each disk 102 comprises an outer annular ring 121, a plurality of vanes 125, and an inner annular ring 122. Each vane 125 has an outer end 126 and an inner end 127. Each vane 125 extends between the outer annular ring 121 and the inner annular ring 122. The outer end 126 is coupled to the outer annular ring 121 and the inner end 127 is coupled to the inner annular ring 122. The inner annular ring 122 of each disk 120 is movably attached to the main center shaft 110.

Preferably, the main center shaft 110 is made of a strong and lightweight material, including, but not limited to, steel (for example, titanium, aluminum, stainless steel, and nickel), carbon fiber (for example, carbon fiber reinforced polymer, carbon fiber reinforced plastic, and carbon fiber reinforced thermoplastic), fiberglass, plastics (for example, polyvinyl chloride), wood and combinations thereof. The main center shaft 110 may optionally be hollow to decrease its weight. Alternatively, the main center shaft 110 may optionally have a foam core to decrease its weight and increase its sturdiness.

Preferably, the outer annular ring 121 is made of a strong and lightweight material, including, but not limited to, steel (for example, titanium, aluminum, stainless steel, and nickel), carbon fiber (for example, carbon fiber reinforced polymer, carbon fiber reinforced plastic, and carbon fiber reinforced thermoplastic), fiberglass, plastics (for example, polyvinyl chloride), wood and combinations thereof. The outer annular ring 121 may optionally be hollow to decrease its weight. Alternatively, the outer annular ring 121 may optionally have a foam core to decrease its weight and increase its sturdiness.

Preferably, the inner annular ring 122 is made of a strong and lightweight material, including, but not limited to, steel (for example, titanium, aluminum, stainless steel, and nickel), carbon fiber (for example, carbon fiber reinforced polymer, carbon fiber reinforced plastic, and carbon fiber reinforced thermoplastic), fiberglass, plastics (for example, polyvinyl chloride), wood and combinations thereof. The inner annular ring 121 may optionally be hollow to decrease its weight. Alternatively, the inner annular ring 122 may optionally have a foam core to decrease its weight and increase its sturdiness.

FIGS. 2 and 3 illustrate alternative embodiments of the disk 102. FIG. 2 shows a disk 102 having an inner annular ring 122 that would be utilized with a main center shaft 110 that has a cross-section that is circular. FIG. 3 shows a disk 102 having an inner annular ring 122 that would be utilized with a main center shaft 110 that has a cross-section that is square. One of ordinary skill in the art understands that the inner annular ring 122 may be manufactured to be utilized with a variety of different main center shafts 110. The embodiment shown in FIG. 3 stabilizes the disk 102 by not allowing the disk 102 to rotate about the main center shaft 110.

The vanes 125 may be made of a lightweight, low-porosity, flexible, strong and windproof material, including, but not limited to, woven nylon fabric, kevlar, and polyethylene terephthalate (dacron, terylene, laysan), and combinations thereof. Furthermore, one or more materials may be applied to the vanes 125 to provide structural support, a fluid/air-tight seal, a resilient structure, bonding surfaces for attachment, protection from the environment (for example, ultraviolet light, solar heating), and protection of the vanes from impact and abrasion. For example, materials that may be applied to the vanes may include, but are not limited to, silicone, urethane, polytetrafluoroethylene, polyimide, polyvinyl chloride, polychloroprene, and combinations thereof.

The outer end 126 may be sewn to create a loop around the outer annular ring 121. Alternatively, the outer end 126 may be connected to the outer annular ring 121 with a lightweight ring, made of, for instance plastic or metal.

Similarly, the inner end 127 may be sewn to create a loop around the inner annular ring 122. Alternatively, the inner end 127 may be connected to the inner annular ring 121 with a lightweight ring, made of, for instance plastic or metal.

The vanes 125 are circumferentially spaced about the outer annular ring 121 and the inner annular ring 122. The vanes 125 are also disposed radially between the outer annular ring 121 and the inner annular ring 122. Spaces 128 between adjacent vanes 125 permit the passage of air. The surface areas of the vanes 125 catch air thereby creating drag as the deceleration apparatus 100 descends. For each vane 125, the outer end 126 is wider than the inner end 127.

The deceleration apparatus 100 may optionally comprise a connector 135 and a cargo container 130. The connector 135 couples the main central shaft 110 to the cargo container 130. The connector 135 may be for example, a hook. The hook may be used to connect to a cargo container 135 with an “eye.” Alternatively, the hook may be used to connect to a cargo net. The connector 135 may be any other connection means known to one of ordinary skill in the art to connect the main center shaft 110 to the cargo container 130, where the cargo container 130 may be a tram, gondola, carriage, shipping container or any other cargo carrier known to one skilled in the art. The cargo may be any transportable article, including, but not limited to humans, livestock, other chattels, and combinations thereof.

The connector 135 may optionally comprise a swivel means. As the deceleration device 100 descends, the main central shaft 110 and the disks 120 may rotate. The swivel means stabilizes the cargo container 130.

Preferably, the cargo container 130 is made of a strong and lightweight material, including, but not limited to, steel (for example, titanium, aluminum, stainless steel, and nickel), carbon fiber (for example, carbon fiber reinforced polymer, carbon fiber reinforced plastic, and carbon fiber reinforced thermoplastic), fiberglass, plastics (for example, polyvinyl chloride), wood and combinations thereof.

The deceleration apparatus 100 includes means for moving each disk 120 along the longitudinal axis of the main center shaft 110. Changing the distance between disks 120 controls the rate of descent of the deceleration apparatus 100. Decreasing the distance between disks 120 by moving the disks 120 closer together, increases the drag forces thereby slowing the descent of the deceleration apparatus 100. Conversely, increasing the distance between disks 120 by moving the disks 120 further apart, decreases the drag forces thereby accelerating the descent of the deceleration apparatus 100.

The means for moving each disk 120 along the longitudinal axis of the main center shaft 110 may be electrical or manual. By way of example, a winch may be utilized. The winch may be electrical (for example, motorized) or manual (for example, hand crank). The winch may utilize ropes and pulleys to move each disk 120. Other means known to one skilled in the art for moving each disk 120 may be utilized by the present invention.

I claim:

1. A deceleration apparatus comprising
a main center shaft;
a plurality of disks; and,
a means for moving each disk along the longitudinal axis of the main center shaft;
wherein each disk comprises an outer annular ring, a plurality of vanes, and an inner annular ring;
wherein each vane having an outer end and an inner end;
wherein each vane extends between the outer annular ring and the inner annular ring;
wherein the outer end is coupled to the outer annular ring;
wherein the inner end is coupled to the inner annular ring; and,
wherein the inner annular ring of each disk is movably attached to the main center shaft.

2. The deceleration apparatus of claim 1, further comprising a connector and a cargo container.

3. The deceleration apparatus of claim 2, wherein the means for moving each disk along the longitudinal axis of the main center shaft includes a motorized winch.
